(19) United States
(12) Patent Application Publication
(10) Pub. No.: US 2011/0153815 A1
(43) Pub. Date: Jun. 23, 2011

(54) INFORMATION PROCESSING APPARATUS HAVING A PLURALITY OF COMMUNICATION INTERFACES AND CONTROL METHOD

(75) Inventor: Hitoshi Aoki, Urayasu-shi (JP)

(73) Assignee: CANON KABUSHIKI KAISHA, Tokyo (JP)

(21) Appl. No.: 12/949,585

(22) Filed: Nov. 18, 2010

(30) Foreign Application Priority Data
Dec. 17, 2009 (JP) 2009-286895

(51) Int. Cl. G06F 15/173

(52) U.S. Cl. 709/224

(57) ABSTRACT

An apparatus having a plurality of interfaces, the apparatus includes a detection unit configured to detect a network address collision of the plurality of interfaces, a confirmation unit configured to confirm whether sub-networks to which the plurality of interfaces is connected are different sub-networks, and a control unit configured to control communication via the plurality of interfaces based on a result of detection by the detection unit and a result of confirmation by the confirmation unit.

### BACKGROUND OF THE INVENTION

1. Field of the Invention

The present invention relates to an information processing apparatus having a plurality of communication interfaces and a control method.

2. Description of the Related Art

An information apparatus having a plurality of communication interfaces has increased and there are some opportunities to simultaneously use the plurality of communication interfaces. There also is an information apparatus virtually having a plurality of communication interfaces although a physical communication interface is one. For example, there is a case that although an information apparatus has only a wireless local area network (LAN) interface, the apparatus simultaneously uses an infrastructure mode and an ad hoc mode by one wireless LAN interface. In such a case, the apparatus simultaneously uses a plurality of communication interfaces in a virtual way.

When an information processing apparatus is connected to an internet protocol (IP) network, an IP address is given to each communication interface. The IP address consists of a network address part and a host address part. The network address indicates which sub-network a terminal belongs to. The host address indicates which terminal on the sub-network. The host address part and the network address part are determined by a net mask. Since the network address is determined for every sub-network, the same network address can be given in different sub-networks.

Therefore, in an information device which simultaneously uses a plurality of communication interfaces, there may be a case that the same network address is given to the plurality of communication interfaces according to a configuration of a network connected to each communication interface. When a user performs network communication, a communication interface used for data transmission is determined by a routing table. In the routing table, it is defined that which communication interface is used for transmission to each sub-network. Further, to the same sub-network, it is defined which communication interface is given priority to perform data transmission.

If the same network address is given to the plurality of communication interfaces, data transmission is performed via a communication interface having priority in the routing table. Therefore, when the plurality of communication interfaces is connected to different networks and a communication partner exists on a sub-network of a communication interface having low priority, the information processing apparatus cannot perform transmission because the communication partner does not exist on a sub-network of the communication interface having high priority. Further, when terminals having the same IP address exist on both sub-networks, the information processing apparatus may communicate to an unintended terminal.

U.S. Pat. No. 7,484,009 (Japanese Patent Application Laid-Open No. 2003-78541) discusses a system for connecting networks, where when an network connection apparatus detects that the same network address is given to a plurality of communication interfaces, the apparatus requests the other terminals existing on a sub-network of a communication interface to change the sub-network address. Further, the apparatus changes the network address of the interface.

However, in the system discussed in U.S. Pat. No. 7,484,009, there can be a case which cannot change the network address to another one due to a network configuration. Further, the system requires times for changing the address, so that data communication cannot be quickly started.

Thus, it is desired to avoid a case where an information processing apparatus cannot communicate a specific terminal and communicates to an unintended terminal because the same network address is assigned to a plurality of communication interfaces. Further, it is also desired that even a user who does not know much about a network can easily understand a possibility of occurrence of such a trouble on the network.

### SUMMARY OF THE INVENTION

According to an aspect of the present invention, an apparatus having a plurality of interfaces includes a detection unit configured to detect a network address collision of the plurality of interfaces, a confirmation unit configured to confirm whether sub-networks to which the plurality of interfaces is connected are different sub-networks, a control unit configured to control communication via the plurality of interfaces based on a result of detection by the detection unit and a result of confirmation by the confirmation unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of a network according to a first or a second exemplary embodiment of the present invention.

FIG. 2 illustrates a configuration of a printer according to the first or the second exemplary embodiment of the present invention.

FIG. 3 is a flowchart illustrating processing executed by the printer according to the first exemplary embodiment of the present invention.

FIGS. 4A and 4B illustrate examples of routing tables at a time of a network address collision according to the first exemplary embodiment of the present invention.

FIG. 5 is a flowchart illustrating processing executed by the printer according to the second exemplary embodiment of the present invention.

### DESCRIPTION OF THE EMBODIMENTS

Various exemplary embodiments, features, and aspects of the invention will be described in detail below with reference to the drawings.

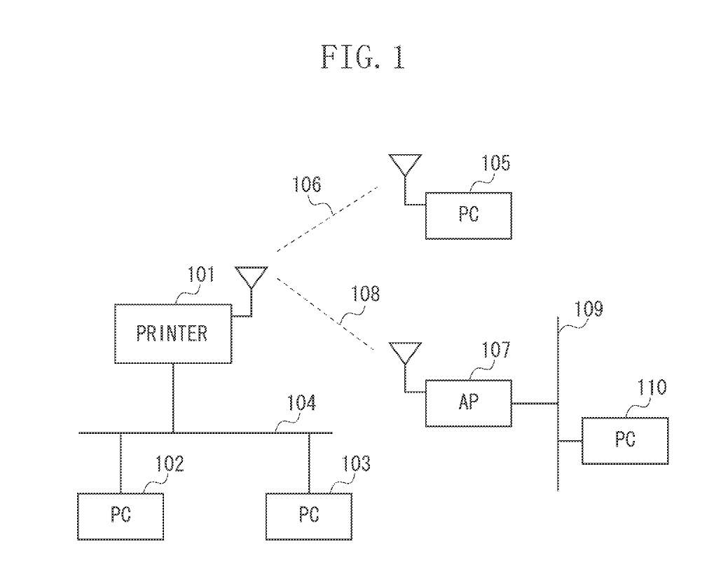

FIG. 1 illustrates a configuration of a network to which the present invention can be applied. A printer 101 includes a wired LAN interface and a wireless LAN interface. The printer 101 is connected to a network 104 via the wired LAN interface. Further, the printer 101 can connect to a wireless ad hoc network 106 or a wireless infrastructure network 108 via the wireless LAN interface. The printer 101 performs predetermined print processing when the printer 101 receives a print job via a network 104, 106, or 108.

Personal computers (PC) 102 and 103 can communicate to the printer 101 via the network 104 and request to perform print processing. A PC 105 includes a wireless interface and can transmit a print job to the printer 101 via the wireless ad hoc network 106. An access point (AP) 107 is a base station of the wireless LAN and serves as a relay between the wireless infrastructure network 108 and a network 109. A PC 110 can transmit a print job to the printer 101 via the network 109, the AP 107, and the wireless infrastructure network 108.

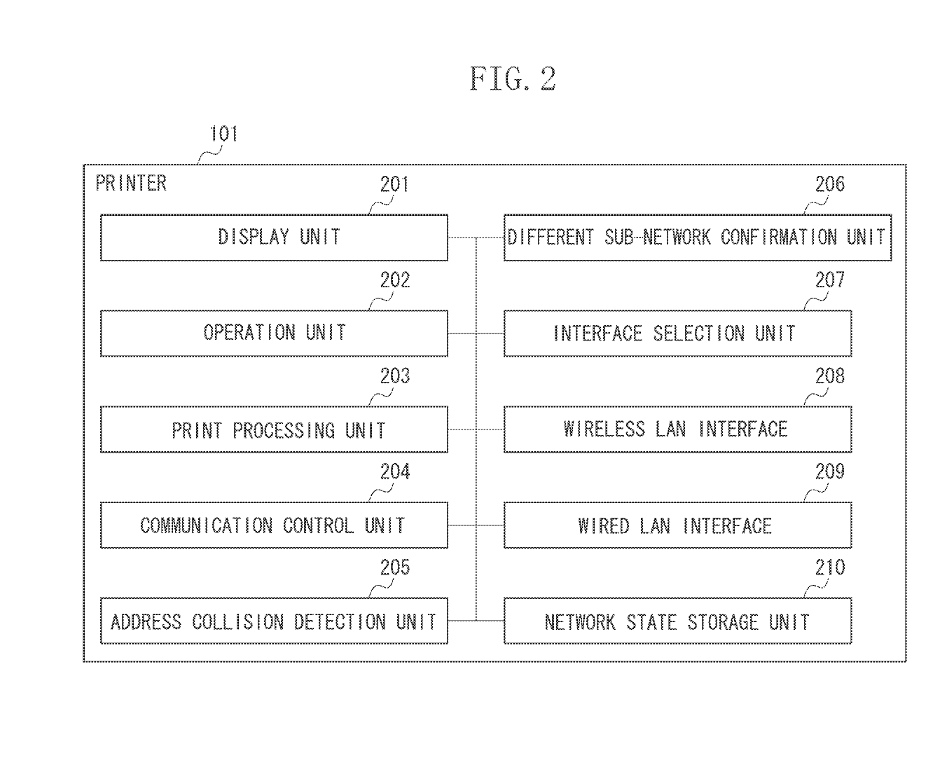

FIG. 2 illustrates a configuration of the printer 101 which is an information processing apparatus. A display unit 201 includes a liquid crystal display and a control program thereof. An operation unit 202 includes buttons and a control program thereof. A print processing unit 203 includes a print motor for executing print processing and a control program thereof. A communication control unit 204 includes a control unit for realizing communication with another terminal on the network by controlling a wireless LAN interface 208 and a wired LAN interface 209, which are described below, and a control program thereof. As for a typical example, transmission control protocol (TCP)/IP control or a communication interface driver corresponds to the communication control unit 204.

An address collision detection unit 205 is a control program for detecting whether network addresses of the wireless LAN interface 208 and the wired LAN interface 209 come into collision with each other. A different sub-network confirmation unit 206 is a control program for confirming whether a sub-network to which the wireless LAN interface 208 is connected is a different sub-network to which the wired LAN interface 209 is connected. An interface selection unit 207 is a control program for selecting a communication interface to be used from the wireless LAN interface 208 and the wired LAN interface 209 according to necessity.

A network state storage unit 210 is a memory for storing a state of the communication interface. For example, the network state storage unit 210 stores information whether the wireless LAN interface 208 is connected to the wireless infrastructure network or the wireless ad hoc network. The wireless LAN interface 208 can connect to a wireless ad hoc network 106 or a wireless infrastructure network 108. The wired LAN interface 209 can communicate with the PC 102 and the PC 103 via the network 104.

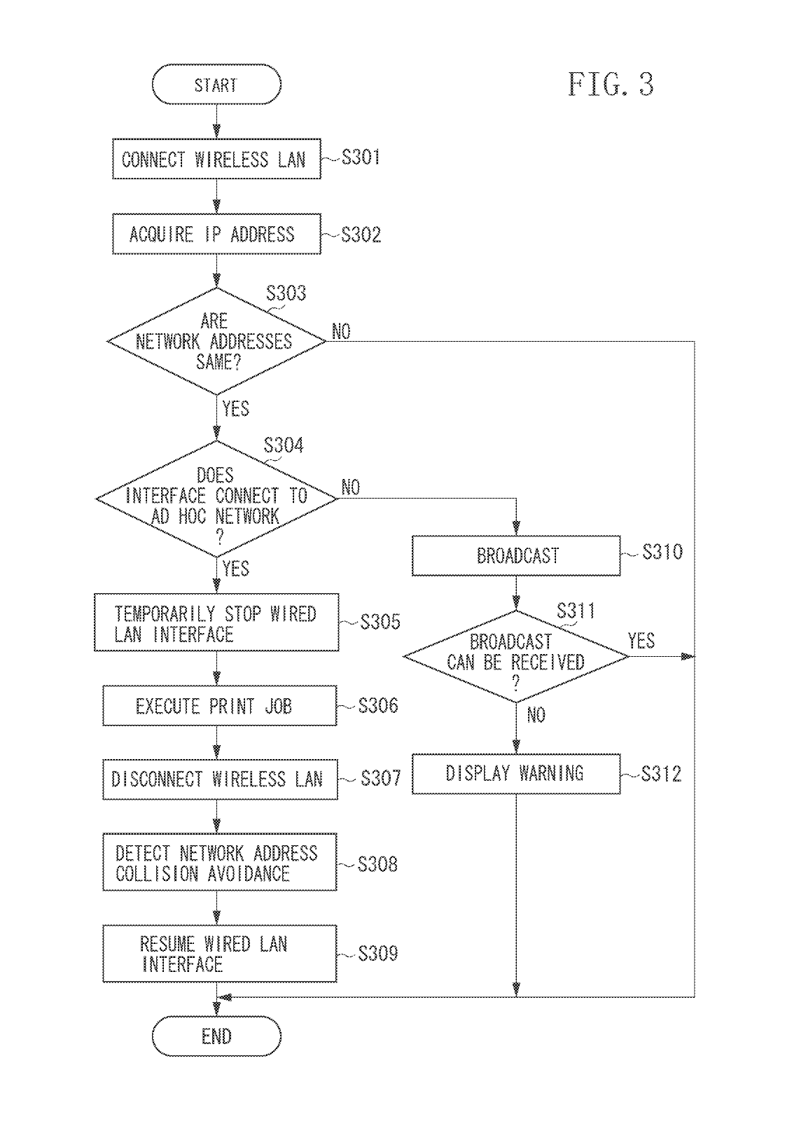

FIG. 3 illustrates an example of an operation performed by the printer 101 according to the first exemplary embodiment. A state of the printer 101 before starting the operation in the present example is that the printer 101 is connected to the network 104 via the wired LAN interface 209 and is communicable to the PC 102 and the PC 103. The wireless LAN interface 208 is in a state not connected to the wireless LAN network. Therefore, the printer 101 cannot communicate with the PC 105 and the PC 110.

Steps S301, S302, and S307 in FIG. 3 are executed by the communication control unit 204. Steps S303 and S308 are executed by the address collision detection unit 205. Steps S304, S310, and S311 are executed by the different sub-network confirmation unit 206. Steps S305 and S309 are executed by the interface selection unit 207. Step S306 is executed by the print processing unit 203. Step S312 is executed by the display unit 201.

The processing executed when the printer 101 connects to the wireless ad hoc network 106 or the wireless infrastructure network 108 will be described with reference to FIG. 3. In the present exemplary embodiment, the case using internet protocol version 4 (IPv4) will be described.

The case in which the printer 101 connects to the wireless ad hoc network 106 will be described. In step S301, the printer 101 establishes the wireless ad hoc network 106 by the wireless LAN interface 208 in order to communicate with the wireless LAN interface of the PC 105, which is not illustrated. At this time, the printer 101 causes the network state storage unit 210 to store information about that the wireless LAN interface 208 is connected to the wireless ad hoc network 106.

In step S302, the printer 101 and the PC 105 acquire an IP address respectively. At this time, it is assumed that the IP address is assigned by an automatic internet protocol (AutoIP) and a network address of 169.254.0.0/255.255.0.0 is assigned to the wireless LAN interface 208 in the printer 101.

After the printer 101 acquires the IP address in step S302, in step S303, the address collision detection unit 205 compares the network addresses of the wired LAN interface 209 and the wireless LAN interface 208.

When the network address of the wired LAN interface 209 is 192.168.0.0/255.255.255.0, as a result of detection, the address collision detection unit 205 determines that the network address of the wired LAN interface 209 is different from the network address of the wireless LAN interface 208 (NO in step S303). In this case, since both the network 104 and the wireless ad hoc network 106 are communicable, the address collision detection unit 205 performs normal processing. For example, the printer 101 executes a print job from the PC 102, the PC 103, and the PC 105.

On the other hand, when the address collision detection unit 205 determines that the network address of the wired LAN interface 209 and the network address of the wireless LAN interface 208 are the same (YES in step S303), the different sub-network confirmation unit 206 executes processing in step S304. The same network address means the case in which, for example, the wired LAN interface 209 also executes AutoIP and has a network address of 169.254.0.0/255.255.0.0.

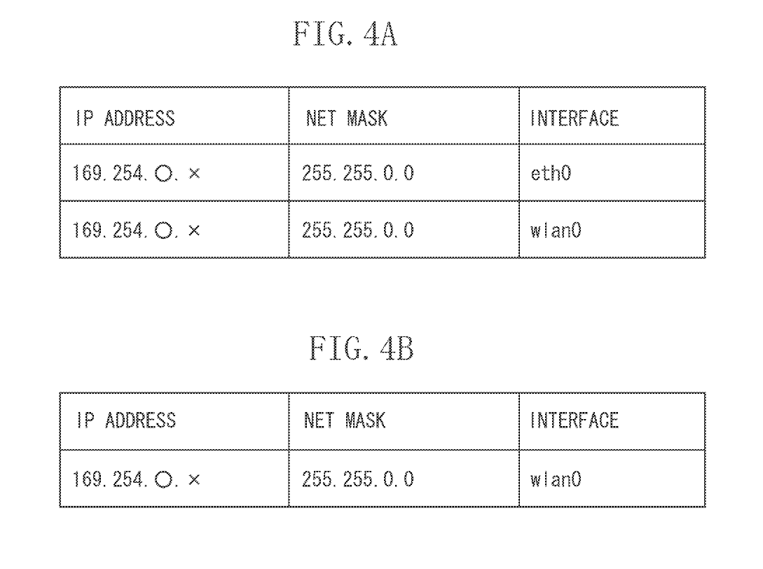

In such a case, a routing table becomes a table illustrated in FIG. 4A. In FIG. 4A, an item “eth0” in an interface term in the routing table indicates the wired LAN interface 209, and an item “wlan0” in the interface term indicates the wireless LAN interface 208. Further, in the routing table, an interface described in an upper row is an interface having higher priority and the interface described in the upper row is selected as an interface to perform data transmission. Thus, in a case in FIG. 4A, even when the printer 101 performs data transmission to the PC 105, eth0, i.e., the wired LAN interface 209 is selected, so that the printer 101 cannot communicate with the PC 105. Further, for example, when the PC 102 and the PC 105 have the same IP address, there is a possibility that the printer 101 accidentally transmits data to the PC 102 although the printer 101 intends to transmit the data to the PC 105.

In step S304, the different sub-network confirmation unit 206 determines whether the wireless LAN interface 208 is connected to the ad hoc network. In other words, the sub-network confirmation unit 206 determines a type of interfaces in which a network address collision occurs. The different sub-network confirmation unit 206 determines at first whether the wireless LAN interface 208 is connected to the wireless infrastructure network 108 or the wireless ad hoc network 106 from the information stored in the network state storage unit 210.

In step S304, if the wireless LAN interface 208 is connected to the wireless ad hoc network 106 (YES in step S304), the different sub-network confirmation unit 206 detects that the wireless ad hoc network 106 is a different sub-network from the wired LAN interface 209, since the ad hoc network is a temporary network. When the different sub-network confirmation unit 206 detects that the wireless ad hoc network 106 is a different sub-network, in step S305, the interface selection unit 207 selects the wireless LAN interface 208 connecting to the temporary network, i.e., the wireless ad hoc network 106 and temporarily stops use of the wired LAN interface 209. As a stopping method, there is a method to down the communication interface in a data link layer, or a method to physically stop electric power supply. In any cases, the printer 101 temporarily stops communication using the wired LAN interface 209.

By this processing, the routing table becomes the table as illustrated in FIG. 4B. Thus, when the printer 101 transmits data to the network with address 169.254.0.0/255.255.255.0, the printer 101 selects the wireless LAN interface 208. Therefore, a communication failure due to the network address collision can be avoided in the printer 101 and the PC 105. In step S306, the printer 101 receives a print job from the PC 105 and the print processing unit 203 executes printing.

After executing print processing, in step S307, the printer 101 and the PC 105 leave from the wireless ad hoc network 106. Simultaneously, the communication processing unit 204 stops use of the wireless LAN interface 208. As the stopping method, there is a method to down the communication interface in the data link layer, or a method to physically stop the electric power supply. In any cases, the printer 101 stops communication using the wireless LAN interface 208.

When the communication processing unit 204 stops the use of the wireless LAN interface 208, in step S308, the address collision detection unit 205 detects that a state of network address collision is avoided. Accordingly, in step S309, the interface selection unit 207 makes the wired LAN interface 209 to be effective again. By this processing, the printer 101 recovers the communication with the network 104. The above described processing is performed when the printer 101 connects to the wireless ad hoc network 106.

Next, the processing executed when the printer 101 connects to the wireless infrastructure network 108 will be described. In step S301, the communication control unit 204 connects to the AP 107 using the wireless LAN interface 208 for participating in the wireless infrastructure network 108. In step S302, the communication control unit 204 acquires an IP address. After the communication control unit 204 acquires the IP address, in step S303, the address collision detection unit 205 compares the network addresses of the wired LAN interface 209 and the wireless LAN interface 208. When the network addresses are different (NO in step S303), the network 104 and the wireless ad hoc network 106 are communicable and the normal processing is executed similarly to the above description.

When the network addresses are the same (YES in step S303), in step S304, the different sub-network confirmation unit 206 identifies whether the wireless LAN interface 206 is connected to the ad hoc network. In this case, the wireless LAN interface 208 is not connected to the ad hoc network 106 but is connected to the wireless infrastructure network 108. When the wireless interface 208 is connected to the wireless infrastructure network 108 (NO in step S304), in step S310, the different sub-network confirmation unit 206 transmits a packet from the wireless LAN interface 208 by broadcasting.

When the packet can be received by the wired LAN interface 209 (YES in step S311), the different sub-network confirmation unit 206 determines that the wired LAN interface 209 and the wireless LAN interface 208 are on the same sub-network. In other words, the fact that the packet broadcasted from the wireless LAN interface 208 can be received by the wired LAN interface 209 indicates that the network 104 and the network 109 are connected to each other.

Accordingly, the packet broadcasted from the wireless LAN interface 208 can be received by the wired LAN interface 209 via the AP 107 and the networks 109 and 104. When the different sub-network confirmation unit 206 determines that the wired LAN interface 209 and the wireless LAN interface 208 connect to the same sub-network, the printer 101 performs normal processing in a state that both the network 104 and the wireless infrastructure network 108 are communicable.

On the other hand, when the packet cannot be received by the wired LAN interface 209 (NO in step S311), the different sub-network confirmation unit 206 determines that the wired LAN interface 209 and the wireless LAN interface 208 are connected to a different sub-network. When the different sub-network confirmation unit 206 determines that the wired LAN interface 209 and the wireless LAN interface 208 are connected to the different sub-networks, there is a possibility that a terminal which is not communicable exists or a possibility that communication is performed with a wrong terminal. Thus, in step S312, the display unit 201 displays a warning to a user, for example, “A communication error may occur, since the same network address is used on the different sub-networks. Please check the network setting.”

According to the present exemplary embodiment, when a network address collision occurs in a plurality of communication interfaces, a user can be notified of a possibility that there is a terminal which is not communicable. Further, the user can be notified of a possibility that communication may be established to a terminal that the user does not intend to use. Furthermore, the present exemplary embodiment can prevent communication with the unintended terminal and occurrence of a state in which communication cannot be performed to a specific terminal which are caused by assigning the same address to the plurality of communication interfaces.

For example, when the printer 101 participates a temporary network such as the wireless ad hoc network, the printer can avoid a communication failure caused by the network address collision by temporarily giving priority to the communication interface of the wireless ad hoc network. When the use of the temporary network is finished, a suspended communication interface is automatically shifted to a usable state. Thus, a user does not need to manually select a communication interface performing data transmission before using the temporary network or after using it, and the communication interfaces can be automatically exchanged according to a using system of the network.

A second exemplary embodiment will be described below. A network configuration according to the second exemplary embodiment is similar to that illustrated in FIG. 1. A configuration of the printer 101 according to the second exemplary embodiment is also similar to that illustrated in FIG. 2. However, the second exemplary embodiment uses an IP address of internet protocol version 6 (IPv6).

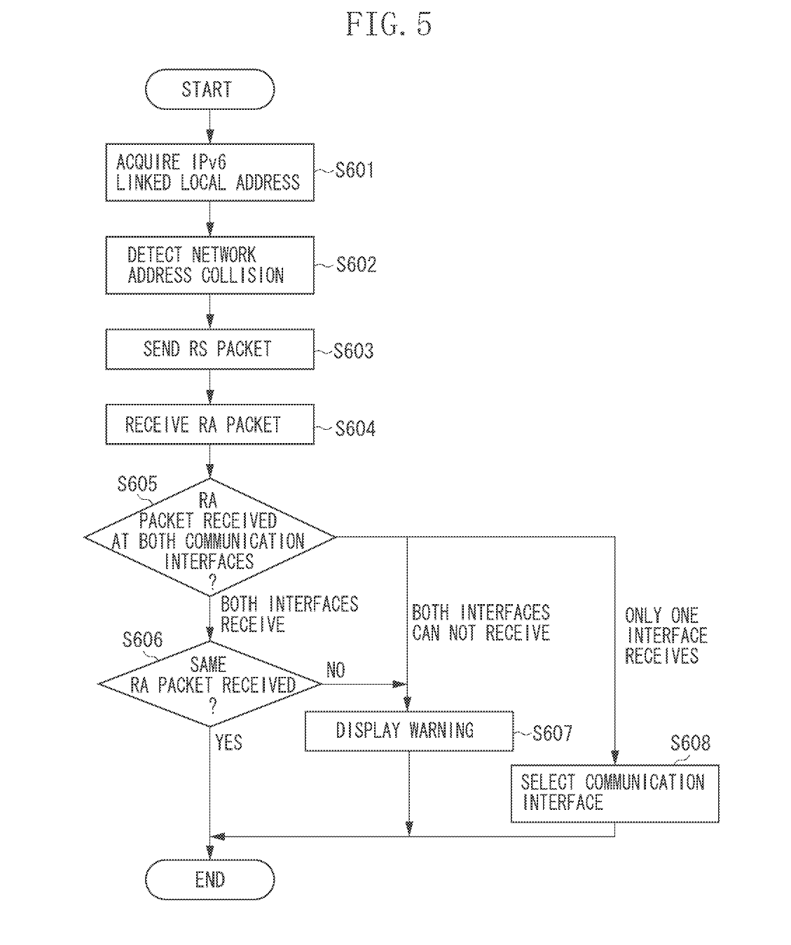

FIG. 5 illustrates an example of an operation performed by the printer 101 according to the second exemplary embodiment. In FIG. 5, steps S601, S603, and S604 are executed by the communication control unit 204. Step S602 is executed by the address collision detection unit 205. Steps S605 and S606 are executed by the different sub-network confirmation unit 206. Step S607 is executed by the display unit 201. Step S608 is executed by the interface selection unit 207.

In the second exemplary embodiment, the printer 101 tries to use IPv6 in the wired LAN interface 209 and the wireless LAN interface 208. The wireless LAN interface 208 is connected to the wireless infrastructure network 108.

In step S601, the communication control unit 204 automatically generates a linked local address of IPv6 and acquires it. The acquired linked local network address of IPv6 is fe80::/10, and is the same network address in the wired LAN interface 209 and the wireless LAN interface 208. Therefore, in step S602, the address collision detection unit 205 detects a network address collision when the linked local address is assigned in each communication interface by IPv6.

Insteps S603 and S604, the communication control unit 204 tries to perform autoconfiguration of IPv6 to each of the wireless LAN interface 208 and the wired LAN interface 209. More specifically, the communication control unit 204 broadcasts a router solicitation (RS) packet from the wireless LAN interface 208 and the wired LAN interface 209. In step S603, the communication control unit 204 requests a router to perform router advertisement (RA) packet transmission. The RA is a response from the router to the RS. Then, in step S604, the wireless LAN interface 208 and the wired LAN interface 209 wait to receive the RA packet from the router for a predetermined time.

In steps S605 and S606, the different sub-network confirmation unit 206 detects whether the network is a different sub-network. In step S605, the different sub-network confirmation unit 206 checks whether the RA packet is received by the wireless LAN interface 208 and the wired LAN interface 209. At this time, the processing is different according to which interface of the wireless LAN interface 208 and the wired LAN interface 209 receives the RA packet.

A case in which both of the communication interfaces receive the RA packet will be described. When both of the communication interfaces receive the RA packet, in step S606, the different sub-network confirmation unit 206 determines whether the received RA packets include the same content. At this time, if the wireless LAN interface 208 and the wired LAN interface 209 are on the same sub-network, the same router transmits the RA packet, so that the both interfaces could have received the same RA packet.

Thus, when the both interfaces can receive the same RA packet, the different sub-network confirmation unit 206 determines that the both interfaces are on the same sub-network (YES in step S606). If the both interfaces are on the same sub-network, both the network 104 and the wireless infrastructure network 108 are communicable, so that the normal processing is performed. More specifically, the different sub-network confirmation unit 206 continues autoconfiguration processing of IPv6 in the wireless LAN interface 208 and the wired LAN interface 209, and establishes a communicable state using IPv6.

On the other hand, when the both interfaces receive the RA packets including different content (NO in step S606), it means that different routers have transmitted the different RA packs. Therefore, in step S606, the sub-network confirmation unit 206 determines that the wireless LAN interface 208 and the wired LAN interface 209 are connected to the different sub-networks. When the different sub-network confirmation unit 206 determines that the wired LAN interface 209 and the wireless LAN interface 208 are connected to the different sub-networks, there is a possibility that a terminal which is not communicable exists or a possibility that communication is performed with a wrong terminal. Thus, in step S607, the display unit 201 displays a warning to a user, for example, “A communication error may occur, since the interfaces are connected to the different sub-networks. Please check the network setting.”

A processing executed when both communication interfaces of the wireless LAN interface 208 and the wired LAN interface 209 cannot receive the RA packet in step S605 will be described. When the both interfaces cannot receive the RA packet, there is a possibility that the wired LAN interface 209 and the wireless LAN interface 208 are connected to the different sub-networks. Therefore, in step S605, the different sub-network confirmation unit 206 determines that the sub-networks are different. Then in step S607, the display unit 201 displays a warning to a user, for example, “A communication error may occur, since the interfaces may be connected to the different sub-networks. Please check the network setting.”

When both of the interfaces cannot receive the RA packet, a case where the network 104 and the wireless network 109 do not normally operate can be also considered. Therefore, the display unit 201 may display a warning different from the one that is displayed when both of the interfaces cannot receive the RA packet. For example, “Please confirm the state of the network. There is a possibility that the network does not normally operate.” can be added to the display of the above described warning to prompt a user to confirm the state of the network.

A case in which only one interface of the wireless LAN interface 208 and the wired LAN interface 209 can receive in step S605 will be described. In step S605, if only the wireless LAN interface 208 can receive the RA packet, the different sub-network confirmation unit 206 determines that the wireless LAN interface 208 and the wired LAN interface 209 are on the different sub-networks. When the different sub-network confirmation unit 206 determines that the wireless LAN interface 208 and the wired LAN interface 209 are on the different sub-networks, then in step S608, the interface selection unit 207 selects the wireless LAN interface 208 which can receive the RA packet as the communication interface to be used. Then, the interface selection unit 207 stops use of the wired LAN interface 209. At this time, the display unit 201 can notify a user of the stoppage of the use of the wired LAN interface 209. In addition, the display unit 201 can display a message for prompting the user to select the communication interface, like “A communication error may occur. You are recommended to use only the wireless LAN interface.”

In step S605, if only the wired LAN interface 209 can receive the RA packet, the different sub-network confirmation unit 206 determines that the wireless LAN interface 208 and the wired LAN interface 209 are on the different sub-networks. When the different sub-network confirmation unit 206 determines that the wireless LAN interface 208 and the wired LAN interface 209 are on the different sub-networks, then in step S608, the interface selection unit 207 selects the wired LAN interface 209 which can receive the RA packet as the communication interface to be used. Then, the interface selection unit 207 stops use of the wireless LAN interface 208. At this time, the display unit 201 can notify a user of the stoppage of the use of the wireless LAN interface 208. In addition, the display unit 201 can display a message for prompting the user to select the communication interface, like “A communication error may occur. You are recommended to use only the wired LAN interface.”

There may be a case that both IP addresses of IPv4 and IPv6 are used. In this case, the processing in the first exemplary embodiment and the processing in the second exemplary embodiment are executed to each address. If it is determined that only the address of IPv6 causes the network address collision in the wireless LAN interface 208 and the wired LAN interface 209 and each interface is connected to the different sub-network, only IPv6 can be stopped. More specifically, only the use of IPv6 in the wired LAN interface 209 can be stopped and IPv4 can be remained in the usable state.

In IPv6, since a linked local address which has the same network address is automatically given, when IPv6 is used in the plurality of communication networks, the network address collision inevitably occurs. By applying the second exemplary embodiment, since the communication interface using IPv6 is automatically selected, the communication failure due to the network address collision can be avoided. Further, if a communication interface by which IPv6 is not used is selected, IPv4 can be used in the selected communication interface. Since another sub-network is detected while performing autoconfiguration of IPv6, the processing can detect the sub-network faster than a method for separately broadcasting a packet such as the first exemplary embodiment. Further, there is a merit that it is not necessary to transmit an unnecessary packet.

The printer 101 includes two communication interfaces of the wired LAN interface and the wireless LAN interface. However, the present invention can be applied to a printer including three interfaces or more. Further, if a printer includes one physical communication interface and a plurality of virtual communication interfaces, the present invention can be applied. As an exemplary embodiment, a single wireless LAN interface which can connect to an infrastructure network and an ad hoc network by its own can be considered. In a case of such a communication interface, it can be regarded that the communication interface includes two virtual interfaces which are the communication interface connecting to the infrastructure network and the communication interface connecting to the ad hoc network, and the present invention can be applied to such case.

In steps S312 and S607, the display unit displays a warning to a user. At this time, the display unit can prompt the user to input which communication interface to be used after displaying the warning to the user.

The present invention can also be realized by executing the following processing. More specifically, software (a computer program) for realizing the functions of the above exemplary embodiments is supplied to a system or an apparatus via a network or various storage media and a computer (or CPU or micro processing unit (MPU)) of the system or the apparatus reads and executes the program. In this case, the program and the storage media storing the program constitutes the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-286895 filed Dec. 17, 2009, which is hereby incorporated by reference herein in its entirety.

What is claimed is:

1. An apparatus including a plurality of interfaces, the apparatus comprising:
a detection unit configured to detect a network address collision of the plurality of interfaces;
a confirmation unit configured to confirm whether sub-networks to which the plurality of interfaces is connected are different sub-networks; and
a control unit configured to control communication via the plurality of interfaces based on a result of detection by the detection unit and a result of confirmation by the confirmation unit.

2. The apparatus according to claim 1, further comprising
a notification unit configured to perform a predetermined notification to a user if an interface in which the network address collision is detected is connected to a different sub-network.

3. The apparatus according to claim 1, further comprising
a selection unit configured to select an interface to be used if the interface in which the network address collision is detected is connected to the different sub-network.

4. The apparatus according to claim 1, further comprising
a determination unit configured to determine a type of the interface in which the network address collision is detected.

5. The apparatus according to claim 4, further comprising
a stopping unit configured to stop communication by one of the interfaces according to a result of determination by the determination unit.

6. The apparatus according to claim 1, wherein the confirmation unit confirms whether the sub-networks to which the plurality of interfaces is connected are different sub-networks based on whether a predetermined packet transmitted from one interface is received via another interface.

7. The apparatus according to claim 1, wherein the confirmation unit confirms whether the sub-networks to which the plurality of interfaces is connected are different sub-networks based on whether a response to a predetermined packet transmitted from the interface in which the network address collision is detected is received via each interface and a content of the response.

8. A method for controlling an apparatus including a plurality of interfaces, the method comprising:
detecting a network address collision of the plurality of interfaces;
confirming whether sub-networks to which the plurality of interfaces is connected are different sub-networks; and
controlling communication via the plurality of interfaces based on a detection result of the network address collision and a confirmation result of whether the sub-networks connected to the plurality of interfaces is the different sub-networks.

9. The method according to claim 8, further comprising performing a predetermined notification to a user if an interface in which the network address collision is detected is connected to a different sub-network.

10. The method according to claim 8, further comprising selecting an interface to be used if the interface in which the network address collision is detected is connected to the different sub-network.

11. The method according to claim 8, further comprising determining a type of the interface in which the network address collision is detected.

12. The method according to claim 8, wherein the confirming confirms whether the sub-networks to which the plurality of interfaces is connected are different sub-networks based on whether a predetermined packet transmitted from one interface is received via another interface.

13. The method according to claim 8, wherein the confirming confirms whether the sub-networks to which the plurality of interfaces is connected are different sub-networks based on whether a response to a predetermined packet transmitted from the interface in which the network address collision is detected is received via each interface and a content of the response.

14. A computer readable storage medium storing a computer program of instructions for causing a computer to perform a method comprising:
detecting a network address collision of a plurality of interfaces;
confirming whether sub-networks to which the plurality of interfaces is connected are different sub-networks; and
controlling communication via the plurality of interfaces based on a result of detection by the detecting and a result of confirmation by the confirming.

15. The computer readable storage medium according to claim 14, further comprising performing a predetermined notification to a user if an interface in which the network address collision is detected is connected to a different sub-network.

16. The computer readable storage medium according to claim 14, further comprising selecting an interface to be used if the interface in which the network address collision is detected is connected to the different sub-network.

17. The computer readable storage medium according to claim 14, further comprising determining a type of the interface in which the network address collision is detected.

18. The computer readable storage medium according to claim 14, wherein the confirming confirms whether the sub-networks to which the plurality of interfaces is connected are different sub-networks based on whether a predetermined packet transmitted from one interface is received via another interface.

19. The computer readable storage medium according to claim 14, wherein the confirming confirms whether the sub-networks to which the plurality of interfaces is connected are different sub-networks based on whether a response to a predetermined packet transmitted from the interface in which the network address collision is detected is received via each interface and a content of the response.
